(19) United States
(12) Patent Application Publication
(10) Pub. No.: US 2006/0278306 A1
(43) Pub. Date: Dec. 14, 2006

(54) Process for adding precision match, dimensional stability, and moisture resistance to solid wood flooring

(76) Inventors: Buddy Earl Williams, Stuart, VA (US); Terri Williams Birkett, Stuart, VA (US); Warren Lee Williams, Stuart, VA (US)

Correspondence Address: TERRI W. BIRKETT, P.O. BOX 619, STUART, VA, 24171, US

(21) Appl. No.: 11/147,738

(22) Filed: Jun. 8, 2005

(51) Int. Cl. B27F 1/00

(52) U.S. Cl. 144/354

(57) ABSTRACT

This process, unique to the flooring industry, includes moulding, sanding, and then adding dimensional stability and moisture resistance to solid wood flooring by sealing all six sides of each piece. In addition to the moisture resistance and superior dimensional stability, accurate moulding and minimal precision sanding result in optimum fit, less overwood. The final result is a prefinished floor that rivals that of a jobsite finished floor.

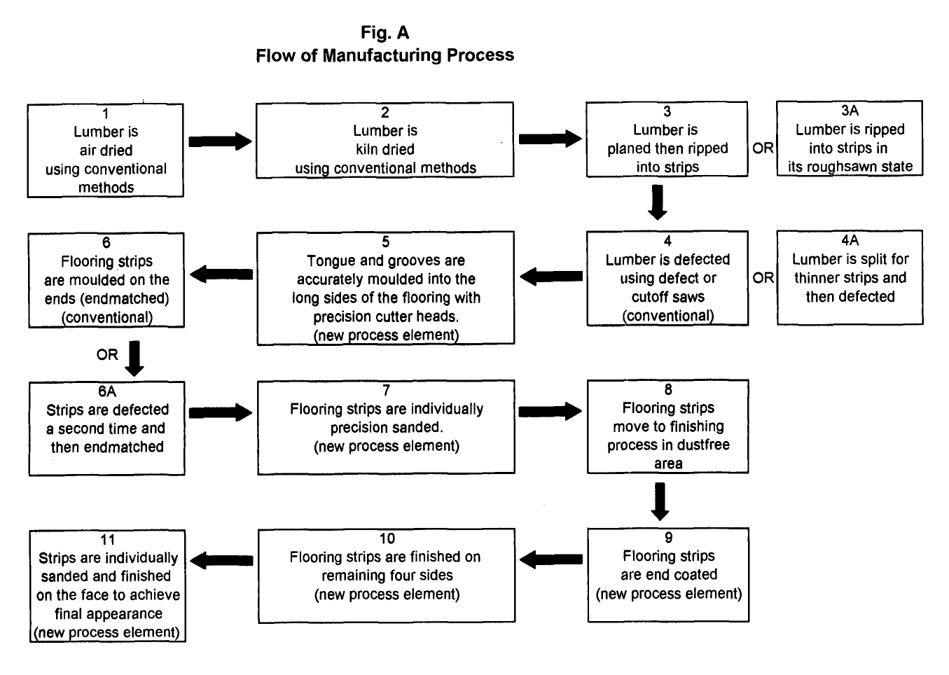

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of solid wood flooring manufacture and more specifically to a process for moulding, sanding, finishing, adding dimensional stability, and adding moisture resistance to solid wood flooring.

Using solid hardwood as flooring is a very old practice. Early wood floors range from halves of logs or boards placed over a dirt floor to nailing sawn wood planks across floor joists. The boards were unsanded and unfinished. As technology progressed, the process for making floorboards included hand planing boards so that they were smoother. An oil, wax, or resin was sometimes rubbed into finer floors to put a ‘seal’ or finish on the top surface of the floor. In order to fit the boards more tightly together and to add strength to the span between the floor joists, a tongue and groove was moulded into the sides of the boards. The development of kiln-drying technology enabled significant improvement in dimensional stability of the wood which was affected by seasonal moisture changes. Most of the later additions to the process of manufacturing solid wood flooring increased its usability, strength, appearance, serviceability, and/or dimensional stability.

Manufacturing jobsite finished solid wood flooring prior to our new process has included some or most of the following steps: sawing logs into boards, air drying and dry-kilning the boards, planing the rough sawn boards, ripping the boards into more narrow strips, sawing out defects, moulding the strips to have a tongue on one long side and a groove on the other long side, moulding the ends of the strip to have a tongue on one end and groove on the other end, installing the strips in a building, sanding the strips after they are installed, and spreading several finish coats on the entire surface of the floor.

Manufacturing factory finished solid wood flooring prior to our new process has included some or most of the following steps: sawing logs into boards, air drying and kiln-drying the boards, planing the rough sawn boards, ripping the boards into more narrow strips, sawing out defects, moulding the strips to have a tongue on one long side and a groove on the other long side, moulding the ends of the strip to have a tongue on one end and groove on the other end, sanding the strips in a gang fashion, rollcoating or spraying finish on the face of the flooring, curing the finish before packaging.

Problems with the prior processes for manufacturing solid wood flooring include: the inaccuracies of gang sanding factory finished floors which results in the creation of overwood, and the five non-sealed (open to moisture) sides of each strip of flooring which result in the pieces lacking dimensional stability due to moisture absorption. In the quest for dimensional stability, processes have included laminating layers of wood together. While this does give some dimensional stability in optimum conditions, engineered and floating floors lack the appeal of solid wood floors in sound, feel, and often, appearance. In an effort to decrease overwood which is sanded into the boards when solid pieces are sanded in a gang fashion, sanders that track on the tongue and grooves have been used, as well as the practice of locking flooring pieces together and then sanding. These means have never been very successful as shown by the predominance of beveled and microbeveled edged strips. The eased edge is used to hide the fact that the pieces are not evenly matched.

### BRIEF SUMMARY OF THE INVENTION

The primary object of the invention is to decrease movement in solid wood floors caused by moisture absorption due to changes in the environment. This is accomplished by increasing moisture resistance as compared to other factory finished floors.

It is another object of the invention to reduce overwood that is consistently seen on other factory finished solid floors

It is another object of the invention to create the look of a job-site finish in a product that has the convenience of a factory finished product.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed the unique aspects of our flooring process which include the moulding, sanding, and finishing of the product. The new process moulding (or horizontal splitting and then moulding) uses conventional means with increased attention to accuracy to attain a more accurately moulded product than is currently available. The increased accuracy requires less sanding of the face of the strip. Each individual piece of flooring is sanded with a linear sander which accurately references the tongue and groove from the face of the flooring. The result is maintaining an accurate match so that less overwood is encountered in the finished product than is currently available from conventional means of gang sanding. Sealing all six sides of each individual strip provides superior moisture resistance and dimensional stability than is currently available in solid wood flooring. The more accurate, square-edge moulded pieces which are factory finished, create a floor that has a near job-site finish appearance which is desirable and unlike any factory finished flooring on the market today. This product has the convenience of a factory finished floor. The same process can be used for beveled or microbeveled products to give them dimensional stability.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

Figure <A> is a flow chart of the operations that comprise the method.

### DETAILED DESCRIPTION OF THE PREFERRED EMBODIMENT

Detailed descriptions of the preferred embodiment of the manufacturing process are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In Figure A, steps 1-12 include conventional and new process elements.

Step 1. Green, roughsawn lumber is air dried to a moisture content of <30% using conventional methods.

Step 2. The air dried lumber is then kiln dried to a moisture content of 6-8% using conventional methods.

Step 3. The lumber is planed to an equalized thickness and then ripped longitudinally into narrow strips. An alternative to Step 3 is to rip roughsawn lumber into narrow strips without planing. Step 3 and its alternative utilize conventional methods.

Step 4. The narrow strips are defected by using cutoff saws which saw out the defects using a transverse cut. An alternative to Step 4 is to add the additional process of splitting the boards horizontally in thickness before or after defecting.

Step 5. The strips are moulded on a moulder or flooring machine/sidematcher. This process moulds a tongue and groove in the the long sides of the strip, planes the top surface of the strip, and moulds the back of the strip. The new process element in this step is to accurately reference the tongue and groove from the face of the flooring. A second new process elment in Step 5 is the use of precision equipment that holds the strip in place strongly enough at the moulding points to compress all bend out of the lumber.

Step 6. The ends of each flooring strip has a tongue or groove sawn horizontally into it, so that the ends can interlock with adjoining pieces.

Step 7. This step involves a new process element. The face of each strip is linearly, individually, and minimally sanded with strict reference to the tongue and groove, so that overwood is not created by exaggerating small fluctuations in tolerances, which are common in conventional methods.

Step 8. The product is moved to a dust free area for finishing.

Step 9. The ends of the strips are coated with a sealer and cured. This is a new process element.

Step 10. The remaining four sides are coated with a sealer and cured. This is a new proces element.

Step 11. The face of each piece is individually finish sanded (or denibbed), coated, and cured to achieve the final finish.

Step 12. Step 11 may be repeated more than once to enhance or customize appearance and durability. The order of steps 7-11 may vary depending on equipment type or the look that is to be achieved.

The three important and unique parts of the process are 1) the precision moulding of the strip, 2) the individual precision sanding of each strip, and 3) the coating/sealing of all six sides of each strip with finish. These three elements combine to provide the added precision needed for a perfect finish match as well as the increased dimensional stability and moisture resistance. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. The said process creates a moulded product that has greater precision with regard to moulding tolerances than is currently available in the market, by utilizing moulders with increased strength at moulding points to take the bend out of the solid wood in order to provide a consistent and accurate longitudinal tongue and groove match.

2. The process utilizes linear, individual and minimal sanding of flooring strips with strict reference of the sanded surface to the side tongue and groove, which maintains the precision moulding tolerances rather than adding to tolerance fluctuations such as is found in the market place today.

3. The process maintains precision tolerances through the finishing process by sealing all six sides of each individual strip to provide superior moisture resistance resulting in much greater dimensional stability than is currently available in the market.
